(19) United States
(12) Patent Application Publication
(10) Pub. No.: US 2019/0002269 A1
(43) Pub. Date: Jan. 3, 2019

(54) FLUID TRACKING MODULE

(71) Applicants: PAUL PETERSON, Chagrin Falls, OH (US); JAMES R. PETERSON, Huron, OH (US)

(72) Inventors: PAUL PETERSON, Chagrin Falls, OH (US); JAMES R. PETERSON, Huron, OH (US)

(21) Appl. No.: 16/025,383

(22) Filed: Jul. 2, 2018

Related U.S. Application Data
(60) Provisional application No. 62/527,137, filed on Jun. 30, 2017.

(51) Int. Cl. B67D 7/34; G07C 5/00; B67D 7/32; B67D 7/24

(52) U.S. Cl. CPC B67D 7/348; B67D 7/243; B67D 7/3281; G07C 5/008

(57) ABSTRACT

A method for tracking fluid delivery from a storage tank to a vehicle operated by a user includes obtaining a user ID and a vehicle ID from the user. The obtained user ID and vehicle ID are compared to a database of authorized user IDs and vehicle IDs. Fluid is allowed to be dispensed from the storage tank to the vehicle if the obtained user ID and vehicle ID match the authorized IDs and vehicle IDs in the database.

### RELATED APPLICATIONS

This application claims the benefit of U.S. Provisional Appln. Ser. No. 62/527,137, filed Jun. 30, 2017, the entirety of which is incorporated by reference herein.

### TECHNICAL FIELD

The present invention relates generally to fluid dispensing and, more specifically, relates to a module for tracking the delivery of and access to fluid from a storage tank to a vehicle.

### SUMMARY

In one example, a method for tracking fluid delivery from a storage tank to a vehicle operated by a user includes obtaining a user ID and a vehicle ID from the user. The obtained user ID and vehicle ID are compared to a database of authorized user IDs and vehicle IDs. Fluid is allowed to be dispensed from the storage tank to the vehicle if the obtained user ID and vehicle ID match the authorized IDs and vehicle IDs in the database.

In another example, a module for tracking fluid delivery from a storage tank to a vehicle operated by a user includes a user interface screen for obtaining a user ID and a vehicle ID from the user. A controller for comparing the obtained user ID and vehicle ID to a database of authorized user IDs and vehicle IDs allows fluid to be dispensed from the storage tank to the vehicle if the obtained user ID and vehicle ID match the authorized IDs and vehicle IDs in the database

Other objects and advantages and a fuller understanding of the invention will be had from the following detailed description and the accompanying drawings.

### BRIEF DESCRIPTION OF THE DRAWINGS

FIG. 1 is a schematic illustration of an example fluid tracking module used in a remote area.

FIG. 2 is a front view of a housing of the module of FIG. 1 having a user interface screen.

FIG. 3 is a front view of the interior of the housing of FIG. 2.

FIG. 4 is a schematic illustration of a log in screen on the user interface screen.

FIG. 5 is a schematic illustration of a user input screen on the user interface screen.

FIG. 6 is a schematic illustration of a user pin key pad screen on the user interface screen.

FIG. 7 is a schematic illustration of a vehicle identification (ID) screen on the user interface screen.

FIG. 8 is a schematic illustration of a vehicle ID key pad screen on the user interface screen.

FIG. 9 is a schematic illustration of a mileage entry screen on the user interface screen.

FIG. 10 is a schematic illustration of a mileage key pad entry screen on the user interface screen.

FIG. 11 is a schematic illustration of a pump enable screen on the user interface screen.

FIG. 12 is a schematic illustration of a data export screen on the user interface screen.

FIGS. 13A-13B illustrate a flow chart for operating the module.

### DETAILED DESCRIPTION

The present invention relates generally to fluid dispensing and, more specifically, relates to a module for tracking the delivery of and access to fluid from a storage tank to a vehicle. Drivers wishing to use the module must enter identification values such as a pin code or scan a barcode. Information about the vehicle to be refueled, e.g., mileage and identification, is also keyed in. The module uses a flow sensor that sends incremental electronic pulses to a controller in response to a predetermined amount of the fuel dispensed. The information can be sent and stored onboard the module and/or wirelessly transmitted to a controller remote to the module, e.g., at an office miles away. The owner or administrator of the module can generate reports tracking the identity of the drivers using the module, the vehicles being refueled, the amount of fuel dispensed, and the like.

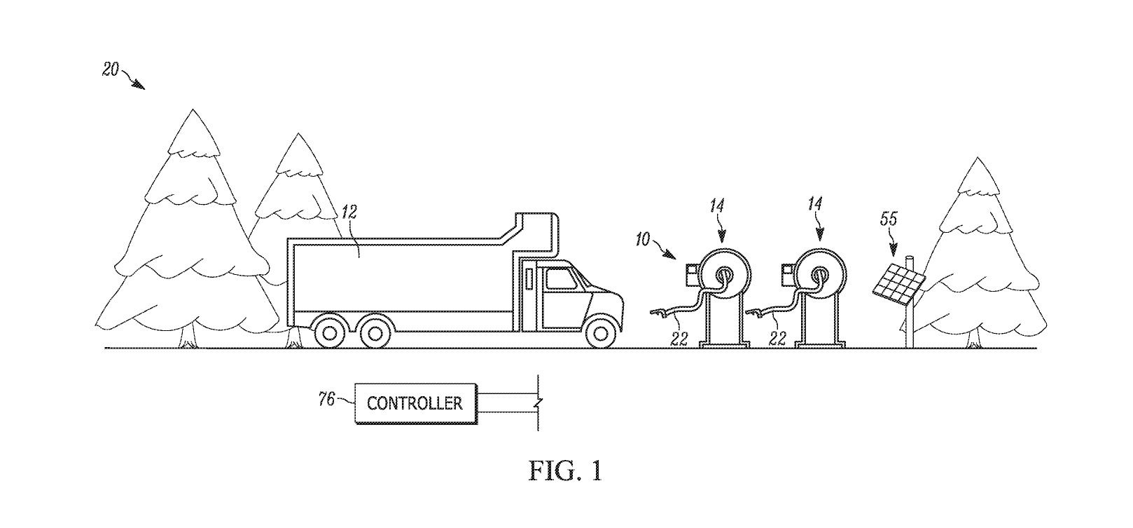

In FIG. 1, an example fluid tracking module 10 is used to deliver and track fluid from one or more storage tanks 14 to a vehicle 12 located in a remote location 20, such as a construction site, unpopulated wilderness area or the like. The module 10 delivers, controls access to, and monitors the dispensing of, a liquid or fuel, e.g., fuel, water, natural gas, etc. In the example described herein, the liquid is a fuel, such as gasoline. A fluid line 22 selectively fluidly connects the storage tank 14 to the vehicle. 12. A pump 26 is associated with each storage tank 14 and, when actuated, draws fuel out of the storage tank to the associated fluid line 22.

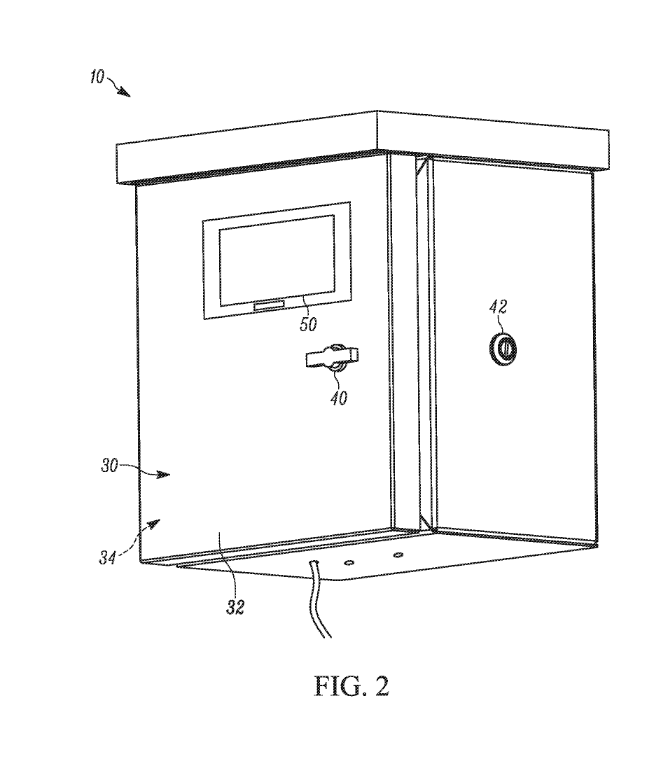

Referring to FIG. 2, the module 10 includes a housing 30 having a door 32 for accessing an interior 34 of the housing. The housing 30 is secured to or adjacent the storage tank(s) 14. A knob 40 is provided on the door 32 for opening and closing the door. A user input and interface screen 50 is exposed through the door 32. A manual key override switch 42 is accessible through the side of the housing 30.

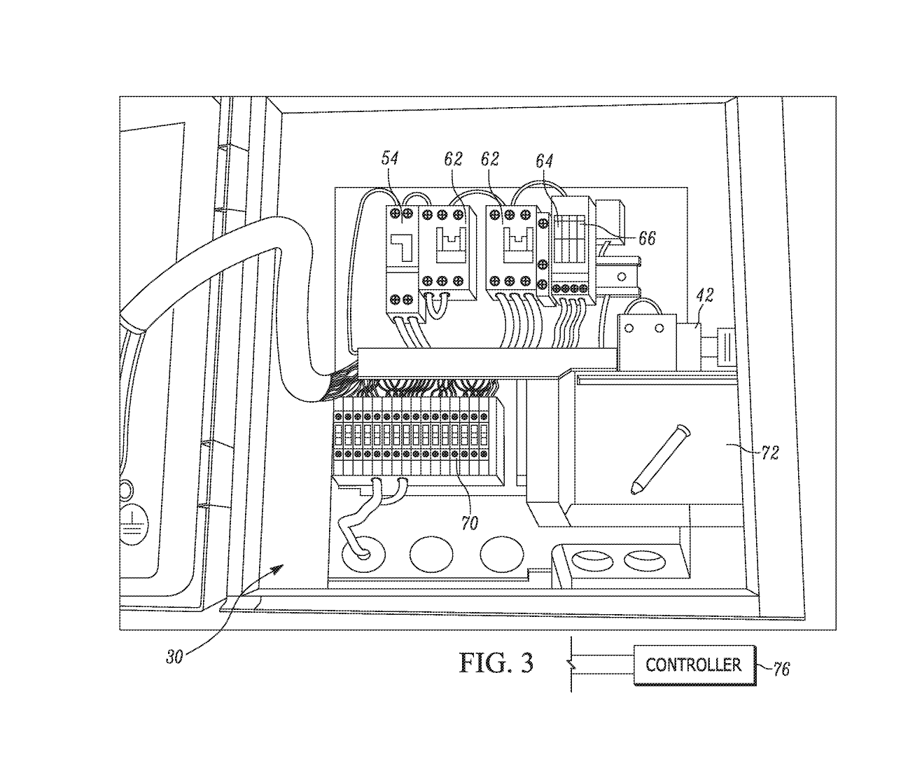

The module 10 includes electronic components 60 within the interior 34 of the housing 30 (see FIG. 3). The electronics 60 can include, for example, the manual key override switch 42, a power supply 54, power contactors 62, relays 64, 66, terminal blocks 70, and a wireless router 72. A controller 76 is connected with the components 60 for control thereof. A power contactor 62 is associated with each fuel pump 26 and, thus, in this example two power contactors are provided in the module 10. The relays 64, 66 can be a 120V relay and a 24V relay, respectively. The wireless router 72 can be an eWON VPN router. The power supply 54 can be a stand alone battery, e.g., a 12V/25V source such as one or more car batteries, or be electrically connected to an external power source, such as a solar panel 55 located at the remote location 20 (see FIG. 1). The solar panel 55 can also recharge the car batteries. In one example, the solar panel 55 can have a maximum power of 30 W, an operating voltage of about 17.2V, an operating current of about 1.74 A, an open circuit voltage 21.6V, and a short circuit current of about 1.93 A.

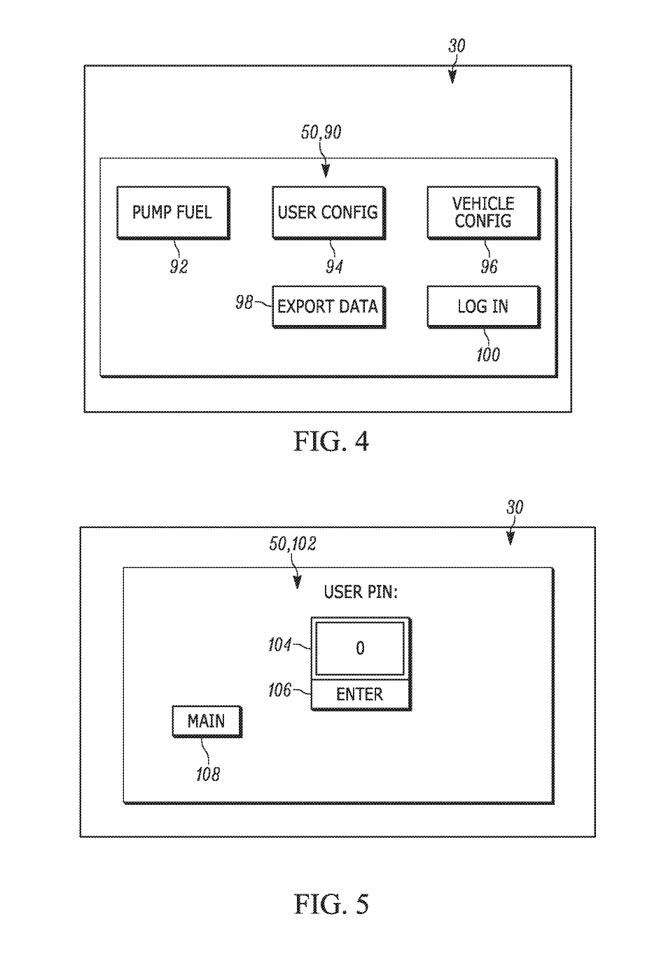

FIG. 4 illustrates the main, log in screen 90 of the user interface screen 50. This screen 90 is the primary interface between the user and the module 10. The screen 90 includes a PUMP FUEL menu button 92 for use by the user wishing to dispense fuel from the storage tank(s) 14. The remaining buttons 94, 96, 98, 100 allow the administrator or owner of the module 10 to control the number of authorized users of the module. In other words, the administrator can predetermine which users are authorized to use the module 10 and dispense fuel from the storage tanks 14. This prevents unauthorized users from accessing the module 10 and dispensing fuel. To this end, a USER CONFIG button 94 allows the administrator to manually input new authorized users along with a unique pin or badge number associated therewith into the module 10.

The VEHICLE CONFIG button 96 allows the administrator to manually input one or more vehicle IDs associated with each authorized user. In other words, the administrator predetermines not only which users can access the module 10 and dispense fuel but which vehicles are permitted to receive the fuel. Consequently, the administrator generates a database in the controller ### that catalogs combinations of users and vehicles that are deemed authorized to dispense fuel from the storage tanks 14.

An EXPORT DATA button 98 allows the administrator to manually extract stored data from the module 10. The LOG ON button 100 allows the administrator to identify themselves as such as thereby access the remaining administrator buttons 94, 96, 98.

Referring to FIG. 5, when a user presses the PUMP FUEL button 92, a user input screen 102 is displayed on the user interface screen 50. The user input screen 102 includes a data entry box 104 requesting the user to provide their unique identification, e.g., pin or badge number. A user wishing to enable the pump 26 must enter their preassigned pin number in the data entry box 104 and then press an ENTER button 106. A MAIN button 108 returns the user to the log in screen 90.

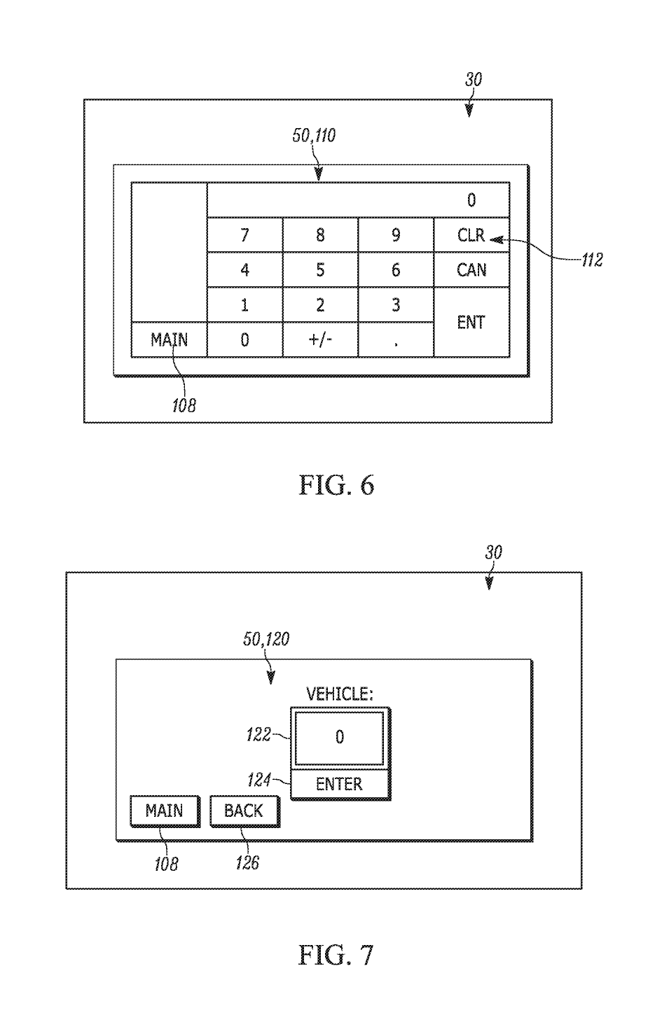

When the data entry box 104 is pressed, a user pin key pad screen 110 (FIG. 6) is displayed on the user interface screen 50. The pin key pad screen 110 includes a keypad 112 allowing the user to enter their preassigned pin number. Alternatively, the module 10 can be equipped with a scanner or card reader (not shown) for scanning an RFID badge of the user. In any case, the user ID is obtained by the controller 76 and compared to the stored database of authorized user IDs. If a match is made, the user is directed to a vehicle identification (ID) screen 120 on the user interface screen 50 (see FIG. 7). If not, the user pin key pad screen 110 is displayed again.

The vehicle ID screen 120 allows the identified, authorized user to enter the ID of the vehicle 12 to be receiving fuel. To this end, the vehicle ID screen 120 includes a data entry box 122 requesting the user to provide the vehicle ID. A user wishing to enable the pump 26 must enter their preassigned vehicle ID in the data entry box 122 and then press an ENTER button 124. The MAIN button 108 returns the user to the log in screen 90. A BACK button 126 returns the user to the user input screen 102.

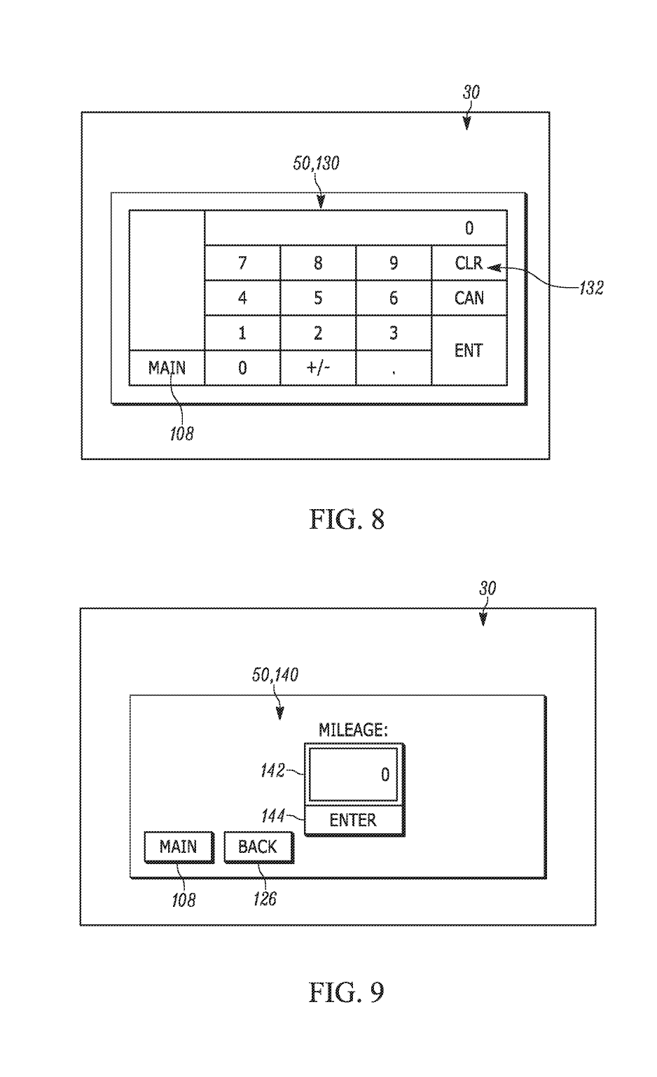

When the data entry box 122 is pressed, a vehicle ID pin key pad screen 130 (FIG. 8) is displayed on the user interface screen 50. The vehicle ID pin key pad screen 130 includes a keypad 132 allowing the user to enter their preassigned vehicle ID. In any case, the vehicle ID is obtained by the controller 76 and compared to the stored database of authorized vehicle IDs. If a match is made the user is directed to a mileage entry screen 140 on the user interface screen 50 (see FIG. 9). If not, the vehicle ID pin key pad screen 130 is displayed again.

The mileage entry screen 140 allows the identified user to enter the current mileage of the vehicle 12 receiving fuel. To this end, the mileage entry screen 140 includes a data entry box 142 requesting the user to provide the vehicle mileage. A user wishing to enable the pump 26 must enter the current mileage of the vehicle 12 in the data entry box 142 and then press an ENTER button 144. Alternatively, the user can enter the number of hours the vehicle 12 has logged at the screen 140 (not shown). The MAIN button 108 returns the user to the log in screen 90. A BACK button 126 returns the user to the vehicle ID screen 130.

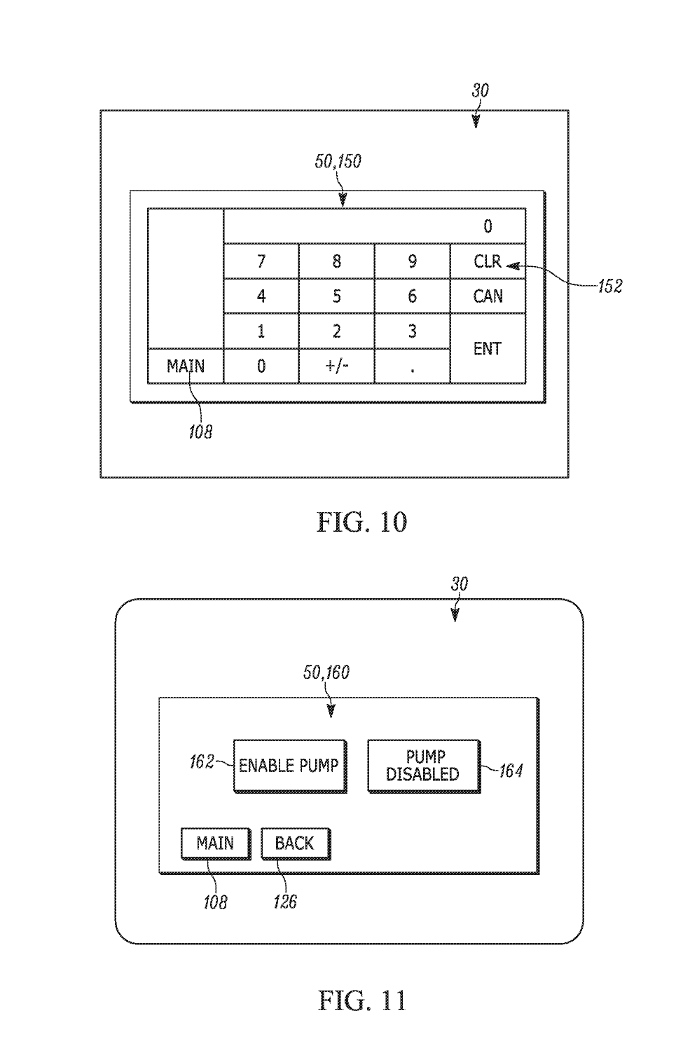

When the data entry box 142 is pressed, a mileage pin key pad screen 150 (FIG. 10) is displayed on the user interface screen 50. The mileage pin key pad screen 150 includes a keypad 152 allowing the user to enter the current mileage of the vehicle 12. The mileage is obtained by the controller 76, which determines whether the entered mileage is a positive, non-zero value. If so, the user is directed to a pump enable screen 160 on the user interface screen 50 (see FIG. 9). If not, the mileage pin key pad screen 150 is displayed again.

The pump enable screen 160 allows the user to enable the pump 26 once the preassigned pin number, vehicle ID, and vehicle mileage have been properly entered and obtained by the controller 76. The pump enable screen 160 includes an ENABLE PUMP button 162 and a PUMP DISABLED button 164. Pressing the ENABLE PUMP button 162 turns the pump 26 on and allows the authorized user to transfer fuel from the storage tank 14 to the authorized vehicle 12. More specifically, pressing the ENABLE PUMP button 162 sends a signal to the power contactor 62, which actuates the pump associated therewith. Once fuel dispensing is complete, the user presses the PUMP DISABLED button 164, which logs the user out and creates a record in the module 10 indicative of the transaction. In one example, a record is created that includes the preassigned pin or badge number of the user, the vehicle ID, the vehicle mileage, the quantity of fuel dispensed, and the timestamp of the transaction. Other data generated and stored can include the ID of the storage tank 14 and pump 26 used. The module 10 then displays the log in screen 90 on the user interface screen 50.

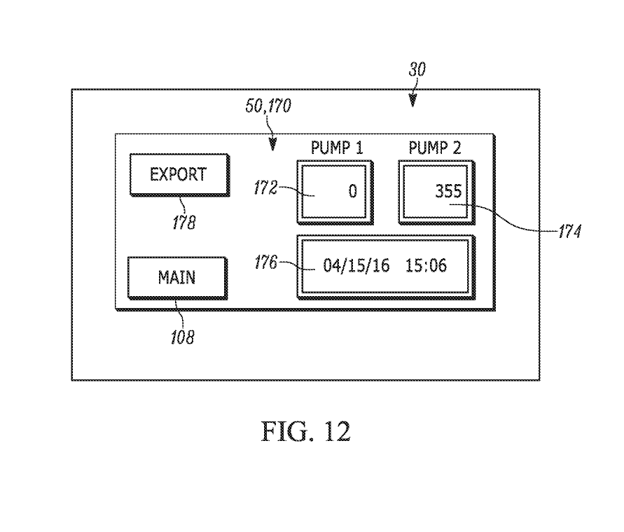

FIG. 12 illustrates a data export screen 170 which is displayed on the user interface screen 50 when the administrator presses the EXPORT DATA button 98 (see FIG. 4). The data export screen 170 includes a PUMP 1 data box 172, a PUMP 2 data box 174, and a timestamp box 176. The number of data boxes shown on the data export screen 170 corresponds with the number of pumps 26 present at the remote area 20 and associated with the module 10. The PUMP 1 and PUMP 2 data boxes 172, 174 display the amount of fuel dispensed by each particular pump 26 during the most recent transaction. The timestamp box 176 displays the date and time at which the most recent transaction was completed. The fuel quantities and associated timestamp are stored in the memory of the module 10 and retrievable by the controller 76. The administrator can immediately export the data displayed on the data export screen 170 (along with the user pin, vehicle ID, and vehicle mileage associated with the transaction) by pressing the EXPORT button 178.

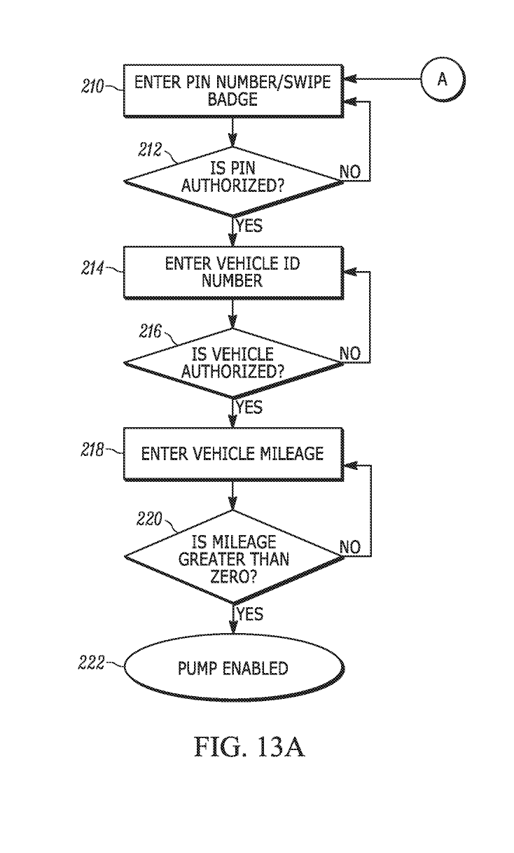

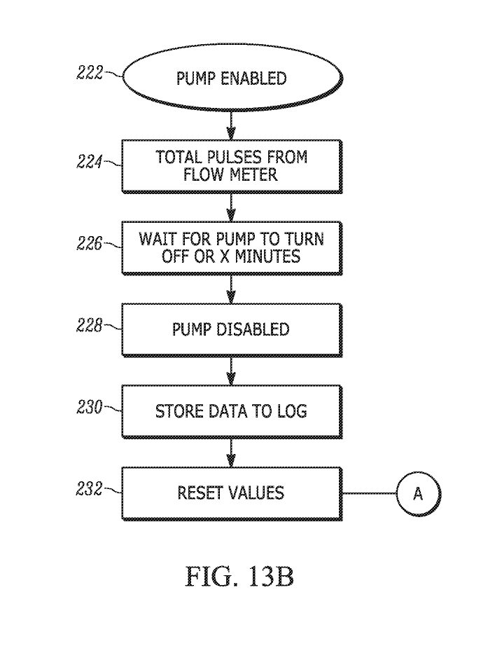

FIGS. 13A-13B illustrate a flow chart showing operation of the module 10. At step 210, the user identifies themselves to the module 10 by either entering their preassigned pin or scanning their RFID badge. At step 212, the module 10 determines if the user is an authorized user by comparing the entered identification with the database of stored identification numbers predetermined by the administrator. If the module 10 determines the user is not authorized, the user is prompted again with the user input screen 102. The module 10 can be programmed to allow a predetermined number of unsuccessful user ID entry attempts to be made within a predetermined time before locking the user out.

If the module 10 determines the user is authorized, the user is prompted with the vehicle ID screen 120 at step 214 and enters the vehicle ID. At step 216, the module 10 determines if the user is attempting to fuel an authorized vehicle by comparing the entered vehicle ID with the database of vehicle IDs stored in the module 10 and associated with the authorized user. If the module 10 determines the user is not authorized to dispense fuel to the vehicle associated with the vehicle ID entered, the user is prompted again with the vehicle ID screen 120. The module 10 can be programmed to allow a predetermined number of unsuccessful vehicle ID entry attempts to be made within a predetermined time before locking the user out.

If the module 10 determines the user is authorized and attempting to dispense fuel to an authorized vehicle, the user is prompted with the mileage entry screen 140 at step 218 and enters the vehicle mileage. The module 10 determines at step 220 whether the mileage is greater than 0. If the determination is true, the module 10 enables the pump 26 at step 222. If the determination is false, the module 10 again prompts the user with the mileage entry screen 140. The module 10 can be programmed to allow a predetermined number of unsuccessful mileage entry attempts to be made within a predetermined time before locking the user out.

Once the pump 26 is enabled, the authorized user is free to dispense fuel to the authorized vehicle 12. At step 224 the module 10 tracks the flow of fuel from the storage tank 14 to the authorized vehicle 12. In one example, a flow meter is provided on the fuel line 22 or storage tank 14 to measure and record the fuel flow.

At step 226, the module 10 either waits for the user to turn the pump 26 off or waits a predetermined amount of time from when the pump is turned on before disabling the pump at step 228. In either case, the module 10 ensures the pump 26 is turned off prior to the next user attempting to access the module. At step 230, the module 10 stores all the data associated with the transaction, e.g., preassigned user pin or badge, vehicle ID, vehicle mileage, quantity of fuel dispensed, the pump ID responsible for dispensing the fuel, and the timestamp of the transaction. The data is stored to a log or database in the memory of the module 10. At step 232, the module 10 resets all the values entered by the user and returns the user interface screen 50 to the user input screen 120 or alternatively the log in screen 90 (not shown).

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method for tracking fluid delivery from a storage tank to a vehicle operated by a user, comprising:
obtaining a user ID from the user;
obtaining a vehicle ID from the user;
comparing the obtained user ID and vehicle ID to a database of authorized user IDs and vehicle IDs; and
allowing fluid to be dispensed from the storage tank to the vehicle if the obtained user ID and vehicle ID match the authorized IDs and vehicle IDs in the database.

2. The method of claim 1 further comprising obtaining a mileage of the vehicle from the user.

3. The method of claim 1 further comprising generating a record each time a user attempts to access fluid from the storage tank, the record including the obtained user ID, obtained vehicle ID, and quantity of fluid dispensed.

4. The method of claim 3 further comprising remotely accessing the records.

5. The method of claim 3 further comprising generating a timestamp when fluid is dispensed and adding the timestamp to each record.

6. The method of claim 1 further comprising preventing fluid from being dispensed when at least one of the obtained user ID and the obtained vehicle ID does not match the database of authorized user IDs and vehicle IDs a predetermined number of times.

7. The method of claim 1 further comprising preventing fluid from being dispensed when the obtained vehicle ID does not match the database a predetermined number of times.

8. A module for tracking fluid delivery from a storage tank to a vehicle operated by a user, comprising:
a user interface screen for obtaining a user ID and a vehicle ID from the user; and
a controller for comparing the obtained user ID and vehicle ID to a database of authorized user IDs and vehicle IDs and allowing fluid to be dispensed from the storage tank to the vehicle if the obtained user ID and vehicle ID match the authorized IDs and vehicle IDs in the database.

9. The module of claim 1, wherein controller generates a record each time a user attempts to access fluid from the storage tank, the record including the obtained user ID, obtained vehicle ID, and quantity of fluid dispensed.

10. The module of claim 9 further comprising a wireless router for remotely accessing the records.

11. The module of claim 9, wherein the record further includes a timestamp when fluid is dispensed.

12. The module of claim 1, wherein the controller prevents fluid from being dispensed when at least one of the obtained user ID and the obtained vehicle ID does not match the database of authorized user IDs and vehicle IDs a predetermined number of times.

13. The module of claim 1, wherein the controller prevents fluid from being dispensed when the obtained vehicle ID does not match the database a predetermined number of times.
